(19) United States
(12) Patent Application Publication
(10) Pub. No.: US 2026/0321890 A1
(43) Pub. Date: Oct. 15, 2026

(54) SEPARATOR FOR ELECTROCHEMICAL DEVICE, AND ELECTROCHEMICAL DEVICE

(71) Applicant: SAMSUNG ELECTRO-MECHANICS CO., LTD., Suwon-si (KR)

(72) Inventors: Seok Ho Yu, Suwon-si (KR); Sun Il Jeong, Suwon-si (KR); Myoung Hoon Kim, Suwon-si (KR); Eui Young Kim, Suwon-si (KR)

(73) Assignee: SAMSUNG ELECTRO-MECHANICS CO., LTD., Suwon-si (KR)

(21) Appl. No.: 19/563,628

(22) Filed: Mar. 11, 2026

(30) Foreign Application Priority Data
Apr. 14, 2025 (KR) 10-2025-0048125
Jun. 18, 2025 (KR) 10-2025-0080372

(51) Int. Cl. H01M 50/463; H01M 50/449

(52) U.S. Cl. CPC H01M 50/463; H01M 50/449

(57) ABSTRACT

A separator for an electrochemical device includes a main plate, and a flow path disposed in the main plate. The flow path includes a first flow path through which a fluid is capable of flowing from a first direction to a second direction, a second flow path through which the fluid is capable of flowing from the second direction to the first direction, and a serpentine flow path disposed between the first and second flow paths.

### CROSS-REFERENCE TO RELATED APPLICATION(S)

This application claims benefit of priority to Korean Patent Application No. 10-2025-0080372 filed on Jun. 18, 2025 and Korean Patent Application No. 10-2025-0048125 filed on Apr. 14, 2025 in the Korean Intellectual Property Office, the disclosures of which are incorporated herein by reference in their entirety.

### TECHNICAL FIELD

The present disclosure relates to a separator for an electrochemical device and an electrochemical device.

### BACKGROUND

Electrochemical devices include fuel cells, which generate electrical energy through the electrochemical reaction of fuel (hydrogen) and an oxidizer (oxygen), electrolysis cells, which generate hydrogen and oxygen through the electrolysis of water, and the like.

Examples of these electrochemical devices include polymer electrolyte membrane fuel cells (PEMFCs) and polymer electrolyte membrane water electrolysis cells (PEMECs), which are eco-friendly hydrogen energy sources and are attracting attention for their high efficiency and miniaturization. Polymer electrolyte membrane fuel cells and polymer electrolyte membrane water electrolysis cells typically include a membrane-electrode assembly (MEA) with a polymer electrolyte membrane disposed between catalyst electrodes. Furthermore, solid oxide fuel cells (SOFCs) and solid oxide electrolysis cells (SOECs) include cells comprised of an air electrode, a fuel electrode, and a solid electrolyte. The cells may be referred to herein as solid oxide cells. Solid oxide fuel cells (SOFCs) generate electrical energy through electrochemical reactions or produce hydrogen by electrolyzing water through the reverse reaction of SOFCs. Other types of fuel cells and electrolysis cell, such as phosphoric acid fuel cells (PAFCs), alkaline fuel cells (AFCs), and direct methanol fuel cells (DMFCs), are also used as electrochemical devices.

Electrochemical devices typically utilize a stacked structure, with a unit cell disposed between a pair of separators. The separators have a flow path through which fluids may flow. Fluids such as water, water vapor, hydrogen, and oxygen gas may flow through the separator flow path, and the direction, speed, flow rate and the like of the fluid significantly impact the performance of the electrochemical device. Therefore, recent research in this field is focused on optimizing the size, shape and the like of the flow path.

### SUMMARY

An aspect of the present disclosure is to implement a separator for an electrochemical device designed to provide high performance when applied to an electrochemical device.

According to an aspect of the present disclosure, a separator for an electrochemical device includes a main plate, and a flow path disposed in the main plate. The flow path includes a first flow path extending in a first direction and a second direction such that a fluid can flow from the first direction to the second direction, a second flow path extending in a first direction and a second direction such that the fluid can flow from the second direction to the first direction, and a serpentine flow path disposed between the first and second flow paths.

According to an aspect of the present disclosure, a separator for an electrochemical device includes a main plate, and a plurality of unit flow path structures disposed in the main plate. At least one unit flow path structure among the plurality of unit flow path structures includes a first flow path, a second flow path, and a serpentine flow path disposed between the first and second flow paths, each of the first, second, and serpentine flow paths including a fluid branching structure.

According to an aspect of the present disclosure, a separator for an electrochemical device includes a main plate including a first region of an outer side and a second region surrounded by the first region, a first through-hole and a second through-hole disposed in the first region, an internal flow path disposed in the second region, a first fluid passage and a second fluid passage connecting the first through-hole and the internal flow path, and a third fluid passage and a fourth fluid passage connecting the internal flow path and the second through-hole. The second region includes a first edge, a second edge, a third edge and a fourth edge, the first and third edges opposing each other in a first direction, and the second and fourth edges opposing each other in a second direction. The first and second fluid passages are connected to the internal flow path at the first and second edges, respectively, and the third and fourth fluid passages are connected to the internal flow path at the third and fourth edges, respectively.

According to an aspect of the present disclosure, an electrochemical device includes a plurality of separators having the structure described above, and an electrochemical cell disposed between the plurality of separators.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating the appearance of a separator for an electrochemical device according to an embodiment;

FIG. 2 is a plan view of the separator of FIG. 1 viewed from one direction;

FIG. 3 illustrates an expanded flow path structure applicable to a separator according to another embodiment;

FIG. 4 illustrates an example of an expanded flow path structure;

FIG. 5 illustrates another example of an expanded flow path structure;

FIG. 6 illustrates another example of an expanded flow path structure;

FIG. 7 illustrates a unit flow path structure applicable to a separator according to a modified embodiment;

FIG. 8 is a plan view illustrating a separator employing the unit flow path structure of FIG. 8;

FIG. 9 is a plan view illustrating a separator according to a modified embodiment;

FIG. 10 is a plan view illustrating a separator according to a modified embodiment;

FIG. 11 is a graph showing the relationship between current density and voltage in an embodiment (one unit flow path structure) and a conventional separator structure;

FIG. 12 is a graph showing the relationship between current density and voltage in an embodiment (2 by 2 unit flow path structures) and a conventional separator structure;

FIG. 13 is a graph showing the relationship between current density and voltage in an embodiment (2 by 3 unit flow path structures) and a conventional separator structure;

FIG. 14 is a graph showing the relationship between current density and voltage in an embodiment (3 by 3 unit flow path structures) and a conventional separator structure;

FIG. 15 is a plan view showing a separator according to another embodiment;

FIG. 16 is a plan view showing a separator according to a modified embodiment of the embodiment of FIG. 15;

FIG. 17 is a cross-sectional view showing an electrochemical device to which a separator according to an embodiment is applied;

FIG. 18 is a cross-sectional view showing a membrane-electrode assembly applicable to an electrochemical device; and

FIG. 19 is an enlarged view of a portion of the membrane-electrode assembly of FIG. 18.

### DETAILED DESCRIPTION

Hereinafter, embodiments will be described with reference to detailed embodiments and the attached drawings. However, the embodiments may be modified in various other forms, and the scope of the present disclosure is not limited to the embodiments described below. Furthermore, the embodiments are provided to more fully explain the present disclosure to those skilled in the art. Therefore, the shapes and sizes of elements in the drawings may be exaggerated for clarity, and elements indicated by the same reference numerals in the drawings represent identical elements.

In addition, in the drawings, for clarity of explanation, irrelevant parts are omitted, and the thickness is enlarged to clearly depict various layers and regions. Components with identical functions within the scope of the same concept are described using the same reference numerals. Furthermore, throughout the specification, when a part is referred to as “including” a component, this does not exclude other components, but rather implies the inclusion of other components, unless otherwise specifically stated.

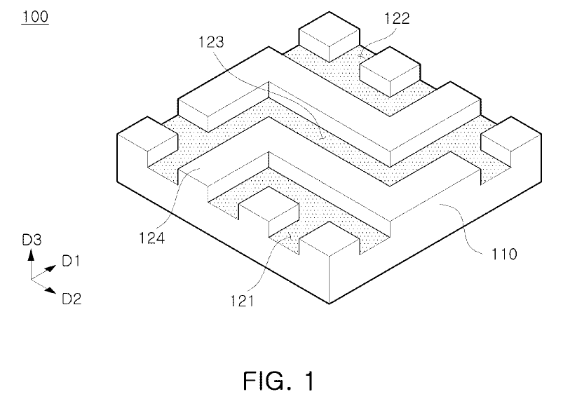

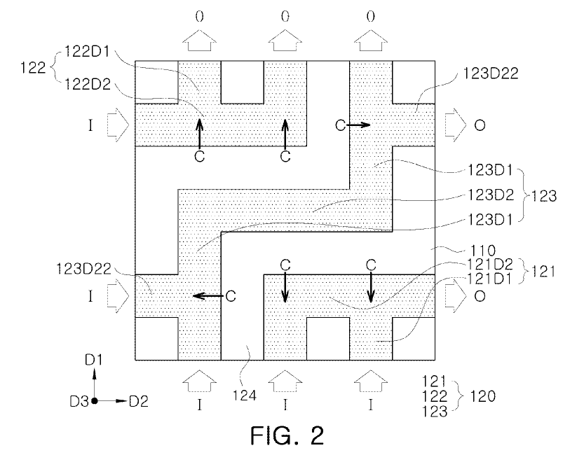

FIG. 1 is a perspective view schematically illustrating the appearance of a separator for an electrochemical device according to an embodiment. FIG. 2 is a plan view of the separator of FIG. 1 viewed from one direction.

Referring to FIGS. 1 and 2, a separator 100 for an electrochemical device (hereinafter referred to as “separator for an electrochemical device” or “separator”) according to an embodiment includes a main plate 110 and a flow path 120 disposed on the main plate 110. In this case, the flow path 120 includes a first flow path 121 through which the fluid may flow from a first direction D1 to a second direction D2, a second flow path 122 through which the fluid may flow from the second direction D2 to the first direction D1, and a serpentine flow path 123 disposed between the first and second flow paths 121 and 122. The fluid may flow from the first direction D1 to the second direction D2, which indicates that the fluid may change its path after flowing in the first direction D1 and then flow in the second direction D2. Similarly, the fluid may flow from the second direction D2 to the first direction D1, which indicates that the fluid may change its path after flowing in the second direction D2 and then flow in the first direction D1.

In this way, in the case of the present embodiment, by having the flow path structure in which the fluid may flow in from the first direction D1 and the second direction D2 and the fluid may flow out in the second direction D2 and the first direction D1, the efficiency of the electrochemical reaction may be improved in the entire area of the separator 100. In addition, this flow path 120 is used as a unit flow path structure and repeated, and may thus be effectively expanded to a large area. Therefore, when the separator 100 of the present embodiment is applied to an electrochemical device, high efficiency may be obtained. For example, when the separator 100 is used as a water electrolysis device, the production efficiency of hydrogen may be increased in the entire area of the separator 100 as the reaction rate of the fuel is controlled and the current density characteristics are improved. The following description focuses on the case where the separator 100 is used as a water electrolysis device. However, even when the separator 100 is used as a fuel cell device, the overall power generation efficiency of the separator 100 may be increased.

The separator 100 is a component that separates individual unit cells in an electrochemical device and may be formed of a conductive material. In detail, the separator 100 may be used in PEMECs and PEMFCs, but may also be used in SOECs or SOFCs, in which case a metal with a high melting point to prevent melting or softening at high temperatures may be used. In the case of the main plate 110 constituting the separator 100, a nickel-based, iron-based, or stainless steel-based material, or the like may be used. Furthermore, if the operating temperature of the separator 100 is relatively low, such as 800° C or lower, the main plate 110 may also include a material with high conductivity, such as copper or a copper alloy. The flow path 120 of the separator 100 is disposed on the main plate 110 and may be formed by a wall 124, as illustrated in the drawing. To form the wall 124 on the main plate 110, a metal plate may be processed using, for example, an appropriate stamping process, an etching process, or the like. Alternatively, the main plate 110 may be formed into a multi-layer structure to form the wall 124 and the flow path 120.

When the separator 100 is used as a water electrolysis device, a fluid such as liquid water or water vapor may be injected through a fluid inlet I, or the liquid water and water vapor may be injected together. Hydrogen gas may be discharged through a fluid outlet O, and vice versa when used as a fuel cell. However, the fluid inlet I and the fluid outlet O may be switched depending on the direction of fluid injection. Hereinafter, the function of the flow path 120 will be described, using a case where the separator 100 is applied to the fuel electrode side of a water electrolysis device as a key example. In the case of the separator 100 disposed on the fuel electrode side of a water electrolysis device, water may be injected from the fluid inlet I. As the fluid flows along the separator 100, the amount of water decreases and the concentration of hydrogen formed by the decomposition of water increases. The flow path 120 of the separator 100 may function to supply reactants while effectively removing products generated by the reaction by moving the products to the fluid outlet O.

Among the components of the flow path 120, the first flow path 121 allows fluid to flow from the first direction D1 to the second direction D2. Conversely, the second flow path 122 allows fluid to flow from the second direction D2 to the first direction D1. In addition, the serpentine flow path 123 is disposed between the first and second flow paths 121 and 122. The serpentine flow path 123 refers to a meandering flow path, and may be a flow path in which the path changes twice or more. In this case, the first and second directions D1 and D2 may be perpendicular to each other, and a direction perpendicular to both the first and second directions D1 and D2 may be defined as a third direction D3. However, the first and second directions D1 and D2 do not have to be strictly perpendicular, and the first and second directions D1 and D2 may not be perpendicular to each other but may be inclined. In the case of having a structure of the flow path 120 as in the present embodiment, the fluid may flow in from a plurality of faces of the separator 100 and flow out to a plurality of faces. In a generally used separator, a fluid flows in from a single face of the separator and flows out to a single face of the separator. Compared to the generally used separator, in the present embodiment, an additional fuel (for example, water) may be supplied to the separator 100, so that an electrochemical reaction may be activated. In addition, in a case in which a fluid flows in and out from a single face, a problem of excessive increase in shear stress in an area in which the path of the fluid changes may occur. However, when the separator 100 of the present embodiment, which has a configuration in which a fluid flows in and out through a plurality of faces, is used, the shear stress deviation within the flow path 120 may be reduced at the same flow rate.

Referring to FIG. 2, looking at a detailed form of the flow path 120, the first flow path 121 may include a fluid branching structure C in which one flow path meets a plurality of flow paths. As a detailed example, the first flow path 121 may include a plurality of first-direction flow paths 121D1 extending in a first direction D1, and a second-direction flow path 121D2 connected to the plurality of first-direction flow paths 121D1 and extending in a second direction D2. In this case, the fluid branching structure C of the first flow path 121 may be disposed in an area in which the first-direction flow path 121D1 and the second-direction flow path 121D2 are connected. In addition, the second flow path 122 may include a fluid branching structure C. In this case, the second flow path 122 may include a second-direction flow path 122D2 extending in the second direction D2, and a plurality of first-direction flow paths 122D1 connected to the second-direction flow path 122D2 and extending in the first direction D1. In this case, the fluid branching structure C of the second flow path 122 may be disposed in an area in which the first-direction flow path 122D1 and the second-direction flow path 122D2 are connected. In addition, the serpentine flow path 123 may include a plurality of first-direction flow paths 123D1 extending in the first direction D1, and a second-direction flow path 123D2 disposed between the plurality of first-direction flow paths 123D1, connected to the plurality of first-direction flow paths 123D1 and extending in the second direction D2. By utilizing the flow path structures of the first and second flow paths 121 and 122, the separator 100 may be provided with multiple fluid inlets I and multiple fluid outlets O, ensuring uniform fluid flow throughout the flow path 120. In this case, in the multiple outer regions of the separator 100, multiple fluid inlets I may be disposed adjacent to each other, and similarly, multiple fluid outlets O may be disposed adjacent to each other. Furthermore, as described below, the separator 100 may be utilized as a unit flow path structure suitable for large-area expansion. The first and second flow paths 121 and 122 may be separated from the serpentine flow path 123.

Similar to the first and second flow paths 121 and 122, the serpentine flow path 123 may include a plurality of fluid branching structures C. In this case, the fluid branching structures C of the serpentine flow path 123 may be respectively disposed in the plurality of first-direction flow paths 123D1. Furthermore, the serpentine flow path 123 may include a plurality of additional second-direction flow paths 123D22 that extend in the second direction D2 and form the fluid branching structure C along with the first-direction flow paths 123D1. In this case, the plurality of additional second-direction flow paths 123D22 may be disposed on opposite sides to each other based on the plurality of first-direction flow paths 123D1.

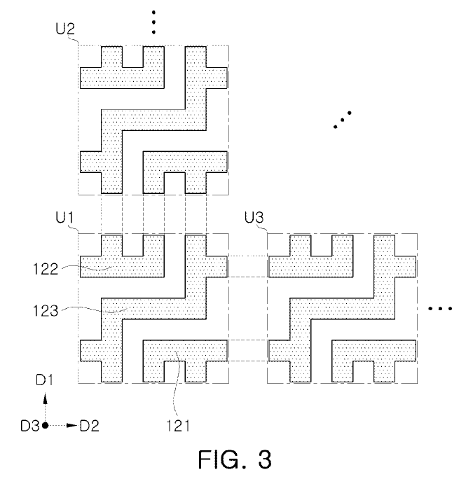

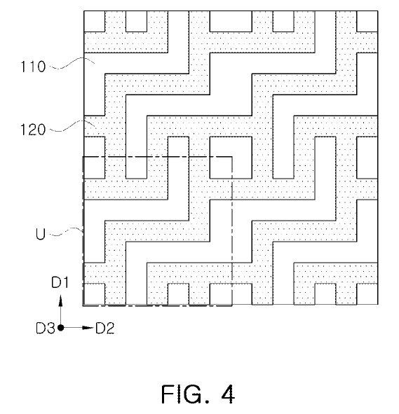

As described above, the flow path 120 of the separator 100 may be used as a unit flow path structure, and the flow path structure may be expanded by arranging a plurality of such unit flow path structures in a repeating manner. In this expanded flow path structure, the flow path shape may become more complex and the area in which the fluid rotates may increase. Accordingly, the retention time of fluids such as fuel water within the separator 100 may be extended, which may be advantageous for activating electrochemical reactions. Referring to FIG. 3, an example of a method in which unit flow path structures are connected and arranged is described. FIG. 3 illustrates an expanded flow path structure applicable to a separator according to another embodiment. FIGS. 4-6 respectively illustrate examples of expanded flow path structures.

At least one (U1, U2 or U3) of the plurality of unit flow path structures U1, U2 and U3 may include first and second flow paths 121 and 122 each including a fluid branching structure (C in FIG. 2), and a serpentine flow path 123 disposed between the first and second flow paths 121 and 122 and including a fluid branching structure (C in FIG. 2). In the present embodiment, three or more unit flow path structures U1, U2 and U3 of the same shape are provided, and a structure is illustrated in which they are repeatedly arranged in the first and second directions D1 and D2. As illustrated in FIG. 3, a plurality of unit flow path structures U1, U2 and U3 include first and second unit flow path structures U1 and U2 adjacent to each other in a first direction D1, and a serpentine flow path 123 of the first unit flow path structure U1 may be connected to a first flow path 121 of the second unit flow path structure U2. In addition, a second flow path 122 of the first unit flow path structure U1 may be connected to a serpentine flow path 123 and the first flow path 121 of the second unit flow path structure U2. Additionally, the plurality of unit flow path structures U1, U2 and U3 may further include a third unit flow path structure U3 adjacent to the first unit flow path structure U1 in the second direction D2. In this case, the serpentine flow path 123 of the first unit flow path structure U1 may be connected to the second flow path 122 of the third unit flow path structure U3. Furthermore, the first flow path 121 of the first unit flow path structure U1 may be connected to the serpentine flow path 123 of the third unit flow path structure U3.

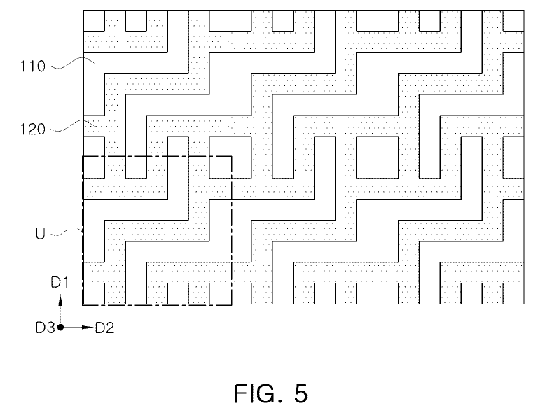

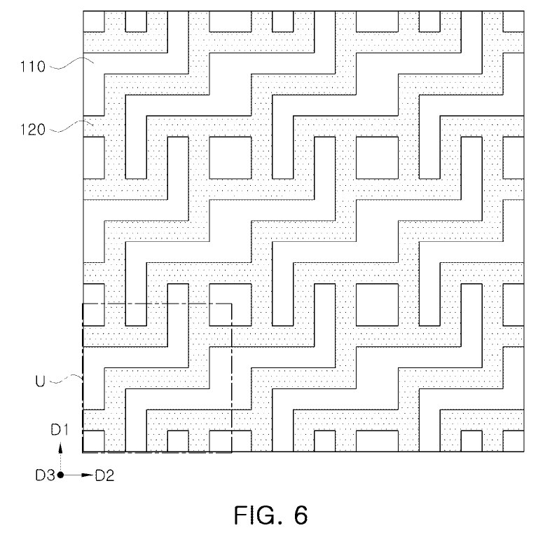

As described above, the first and second directions D1 and D2 may be perpendicular to each other, and in this case, the plurality of unit flow path structures U1, U2 and U3 may be arranged in a grid form. When arranged in a grid form, the number of a plurality of unit flow path structures U1 and U2 arranged in the first direction D1 and the number of a plurality of unit flow path structures U1 and U3 arranged in the second direction D2 may be the same. Conversely, the number of a plurality of unit flow path structures U1 and U2 arranged in the first direction D1 and the number of a plurality of unit flow path structures U1 and U3 arranged in the second direction D2 may be different. FIGS. 4 to 6 illustrate examples in which a plurality of unit flow path structures U1, U2 and U3 are arranged. Based on the number of unit flow path structures arranged in the first direction D1 and the number of unit flow path structures arranged in the second direction D2, FIG. 4 illustrates an example of a unit flow path structure U arranged in 2 by 2, FIG. 5 illustrates an example of a 2 by 3 arrangement, and FIG. 6 illustrates an example of a 3 by 3 arrangement.

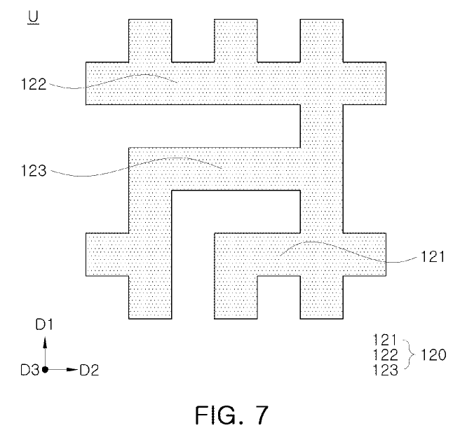

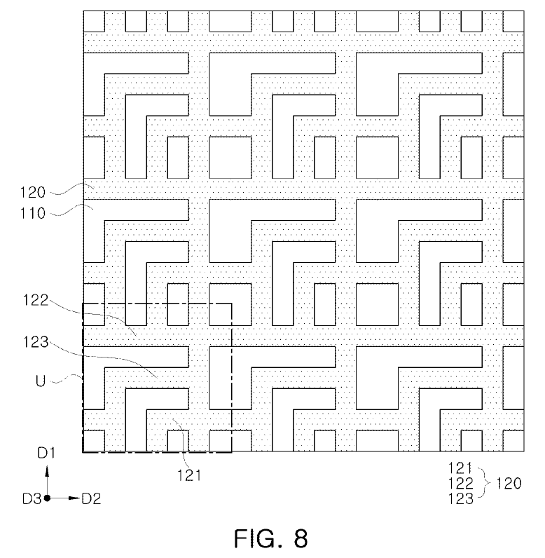

Meanwhile, in the above-described embodiment, the first and second flow paths 121 and 122 are separated from the serpentine flow path 123, but may be connected to each other. For example, in the unit flow path structure U, the first and second flow paths 121 and 122 may be connected to the serpentine flow path 123. FIG. 7 shows a unit flow path structure U in which the first and second flow paths 121 and 122 are connected to the serpentine flow path 123, and FIG. 8 shows an expanded form in which the unit flow path structures U of FIG. 7 are arranged in a 3 by 3 grid structure. As in the modified examples of FIGS. 7 and 8, when the first and second flow paths 121 and 122 are connected to a serpentine flow path 123, fluids such as water may be effectively supplied to areas with relatively long fluid flow paths, for example, the upper right region based on the drawing, thereby reducing the problem of uneven current density depending on areas during electrochemical device operation.

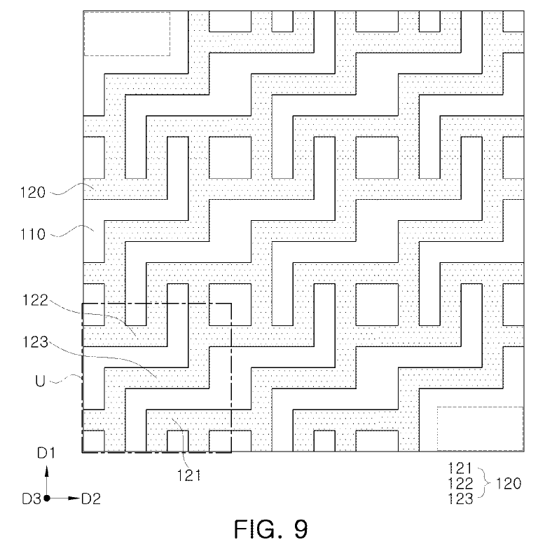

Next, the modified example of FIG. 9 is a form in which some flow paths are removed from a large-area expanded flow path structure. In detail, among a plurality of unit flow path structures U, one of the diagonally opposite unit flow path structures may not include the first flow path 121, and the other may not include the second flow path 122. In FIG. 9, the dotted line area in the lower right corresponds to the area in which the first flow path 121 has been removed, and the dotted line area in the upper left corresponds to the area in which the second flow path 122 has been removed. In areas where the flow path is removed, the fluid flow path is relatively short. As the flow path expands and becomes larger in area, the flow rate increases. However, in this case, in areas with short flow paths, shear stress may increase excessively, leading to uneven current density during operation of the electrochemical device. In the modified example of FIG. 9, this negative effect is reduced by removing some of the flow paths that may increase shear stress.

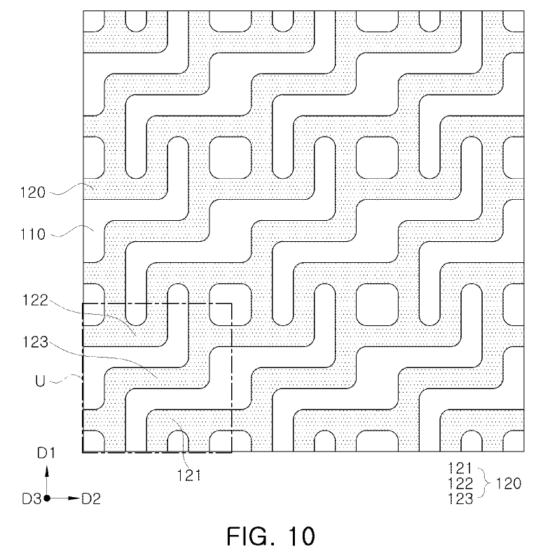

Next, in a modified example of FIG. 10, the flow path 120 has a structure with curved side surfaces. This curved shape may further facilitate smooth fluid flow. In this case, the curved surface of the flow path 120 may be disposed in areas where the direction of extension of the flow path 120 changes.

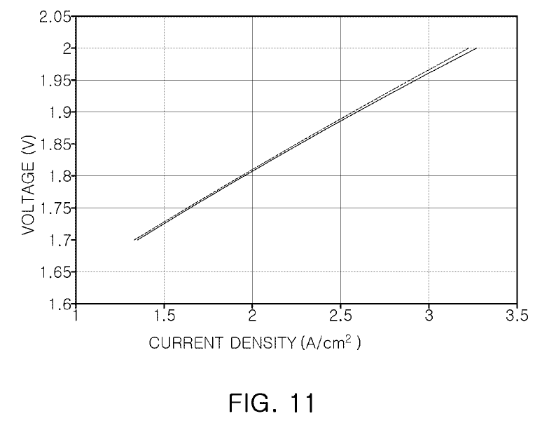

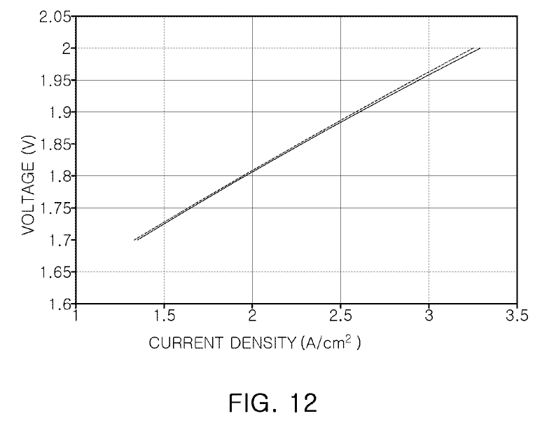

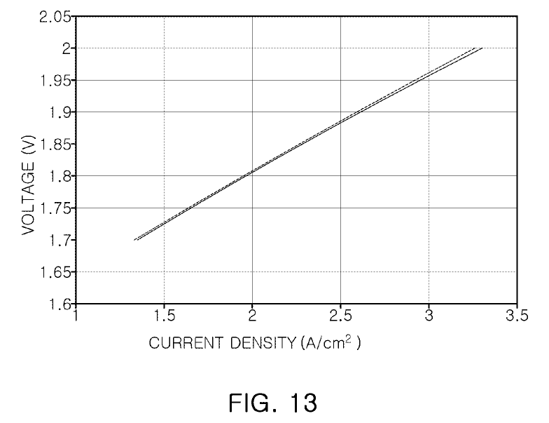

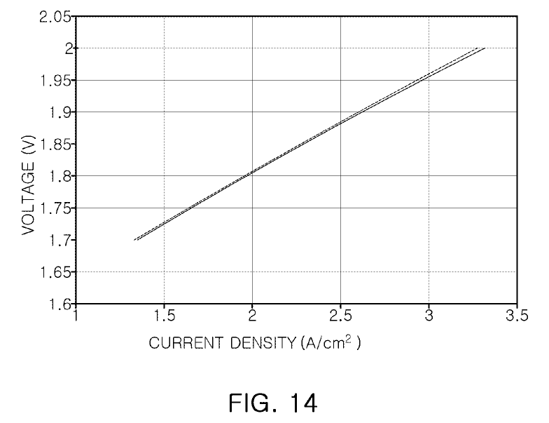

Referring to FIGS. 11-14, the results of comparing the characteristics of separators according to flow path shapes will be described. FIGS. 11-14 are graphs showing the relationship between current density and voltage according to the flow path shape of the separator, and compare the performance of an embodiment (solid line) of the present disclosure and a technology of a conventional separator (dotted line), respectively. In the case of the embodiment of the present disclosure, as a separator using the unit flow path structure of FIG. 2, FIG. 11 illustrates that one unit flow path structure is disposed, FIG. 12 illustrates a 2 by 2 arrangement, FIG. 13 illustrates a 2 by 3 arrangement, and FIG. 14 illustrates a 3 by 3 arrangement. In the case of the technology of the conventional separator, a structure in which line-shaped flow paths are arranged in one direction is used as a separator with the same area as the embodiment. Looking at the performance comparison results, in the case of FIG. 11, even when one unit flow path structure was used, an improvement in current density of about 0.9% was illustrated at the same voltage compared to the technology of the conventional separator. In addition, when the unit flow path structure was arranged as 2 by 2, an improvement of about 1.1% was illustrated (FIG. 12), when it was arranged as 2 by 3, an improvement of about 1.18% was illustrated (FIG. 13), and when it was arranged as 3 by 3, an improvement of about 1.2% was illustrated (FIG. 14). In this way, when the unit flow path structure proposed in the embodiment is used, it can be confirmed that the improvement effect of current density increases, especially when applied to a large-area separator.

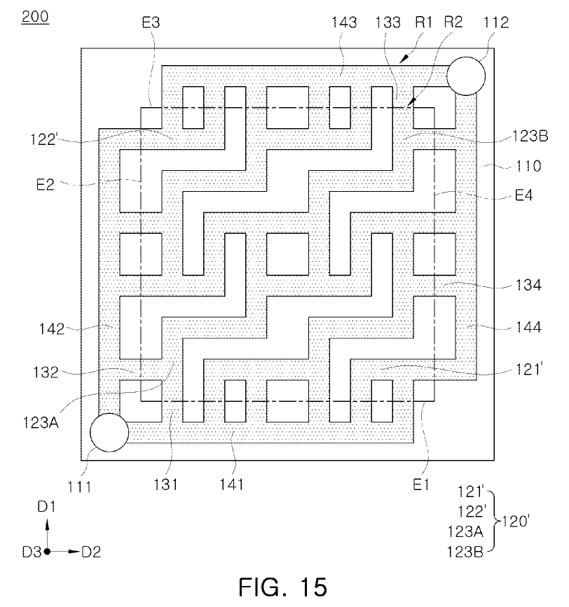

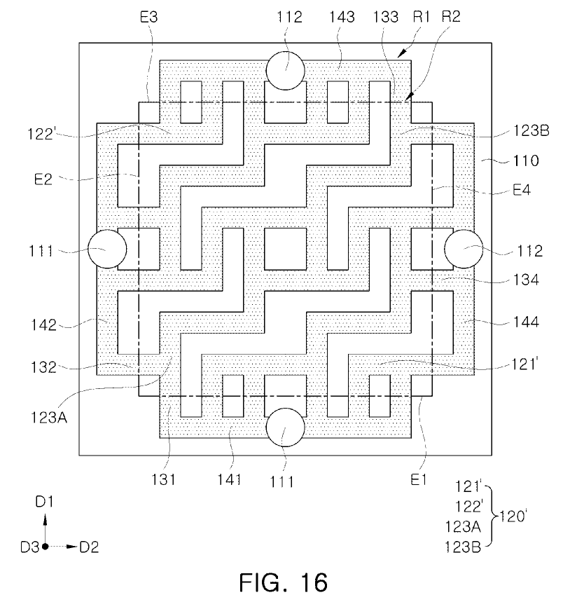

Meanwhile, although the above-described embodiment shows a structure in which the fluid inlet and outlet of the separator are disposed at the edges of the separator, the way in which the fluid flows in and out may be changed. This will be described with reference to FIGS. 15 and 16. First, as in the modified example of FIG. 15, a separator 200 includes a main plate 110, through-holes 111 and 112, an internal flow path 120’, and first to fourth fluid passages 131 to 134. The main plate 110 includes a first region R1 on the outside and a second region R2 surrounded by the first region R1. In this case, the first and second regions R1 and R2 do not need to be physically separated regions, and may be divided by a virtual separation line. In the main plate 110, the second region R2 includes first to fourth edges E1 to E4, with the first edge E1 and the third edge E3 opposing each other in the first direction D1, and the second edge E2 and the fourth edge E4 opposing each other in the second direction D2.

The first and second through-holes 111 and 112 are disposed in the first region R1, and the internal flow path 120’ is disposed in the second region R2. The first and second through-holes 111 and 112 may serve as passages through which fluid may flow in and out from the outside. The internal flow path 120’ may have a flow path structure similar to the flow path structure of the separator of the previously described embodiments, for example, a flow path structure in which unit flow path structures (such as the flow path structure of FIG. 2) are repeatedly arranged. The first and second fluid passages 131 and 132 connect the first through-hole 111 and the internal flow path 120’, and in this case, the connection does not only mean the case of direct connection. For example, other flow paths besides the first and second fluid passages 131 and 132 may be interposed between the first through-hole 111 and the internal flow path 120’. As a detailed example, the first and second fluid passages 131 and 132 are connected to the internal flow path 120’ at the first and second edges E1 and E2, respectively. In addition, the third and fourth fluid passages 133 and 134 connect the internal flow path 120’ and the second through-hole 112, and in this case, the connection does not only mean the case of direct connection. For example, in addition to the third and fourth fluid passages 133 and 134, other flow paths may be interposed between the second through-hole 112 and the internal flow path 120’. As a detailed example, the third and fourth fluid passages 133 and 134 are connected to the internal flow path 120’ at the third and fourth edges E3, E4, respectively. In this case, the first and second fluid passages 131 and 132 may serve as fluid inlet passages, and the third and fourth fluid passages 133 and 134 may serve as fluid outlet passages. Accordingly, fluid may flow into the internal flow path 120’ from adjacent edges while flowing out from other adjacent edges, thereby improving the efficiency of the electrochemical reaction across the entire area of the separator 200.

As illustrated in the illustrated form, a plurality of first fluid passages 131 may be provided, and in this case, a plurality of first fluid passages 131 and a first common flow path 141 connected to the first through-hole 111 may be disposed in the first region R1. Similarly, a plurality of second fluid passages 132 may be provided, and in this case, a plurality of second fluid passages 132 and a second common flow path 142 connected to the first through-hole 111 may be disposed in the first region R1. In addition, a plurality of third fluid passages 133 may be provided, and in this case, a plurality of third fluid passages 133 and a third common flow path 143 connected to the second through-hole 112 may be disposed in the first region R1. Additionally, multiple fourth fluid passages 134 may be provided. In this case, a plurality of fourth fluid passages 134 and a fourth common flow path 144 connected to the second through-hole 112 may be disposed in the first region R1.

The internal flow path 120’ may include a first connecting passage 123A connected to the first and second fluid passages 131 and 132. In this case, the first connecting passage 123A may include a serpentine flow path, which may be the same flow path as the serpentine flow path 123 in the embodiment of FIG. 2. Similarly, the internal flow path 120’ may further include a second connecting passage 123B connected to the third and fourth fluid passages 133 and 134. In this case, the second connecting passage 123B may include a serpentine flow path, and may be the same flow path as the serpentine flow path 123 in the embodiment of FIG. 2. The first and second connecting passages 123A and 123B within the second region R2 may be connected to each other. In addition, the internal flow path 120’ may further include a third connecting passage 122’ connected to the second and third fluid passages 132 and 133, and the third connecting passage 122’ corresponds to the second flow path 122 in the embodiment of FIG. 2. In this case, the third connecting passage 122’ may be separated from the first and second connecting passages 123A and 123B. Alternatively, as in the embodiment described in FIG. 7, the third connecting passage 122’ may be connected to the first and second connecting passages 123A and 123B. Additionally, the internal flow path 120’ may further include a fourth connecting passage 121’ connected to the first and fourth fluid passages 131 and 134, which may be identical to the first flow path 121 in the embodiment of FIG. 2. In this case, the fourth connecting passage 121’ may be separated from the first and second connecting passages 123A and 123B. Alternatively, as in the embodiment described in FIG. 7, the fourth connecting passage 121’ may be connected to the first and second connecting passages 123A and 123B.

In the present embodiment, the first and second through-holes 111 and 112 may each be provided in a single instance, and in this case, the first and second through-holes 111 and 112 may be disposed at diagonally opposite locations on the main plate 110. In contrast, as in the modified example of FIG. 16, the first and second through-holes 111 and 112 may each be provided in plural, and FIG. 16 shows a structure in which the first and second through-holes 111 and 112 are each provided in two through-holes.

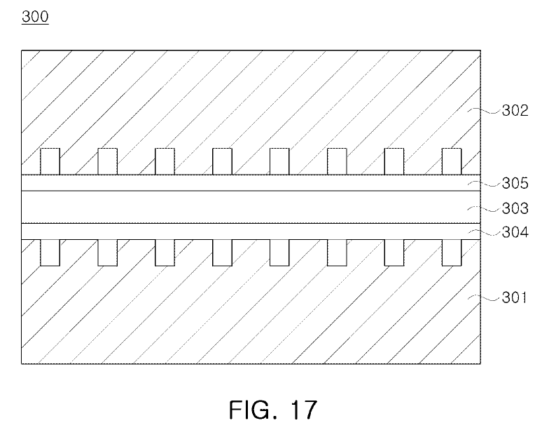

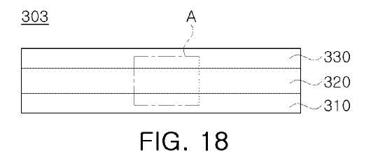

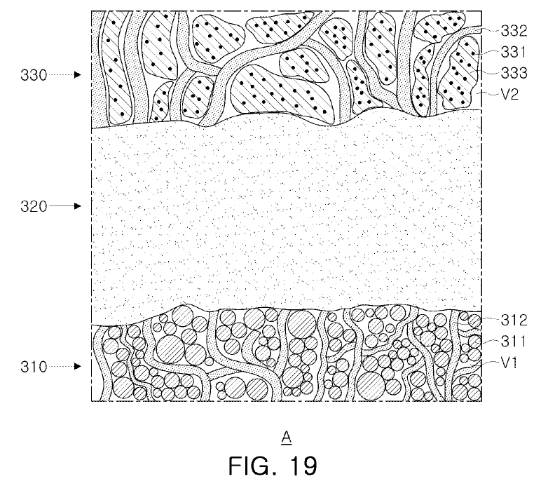

An example of applying the separator described above to an electrochemical device will be described with reference to FIGS. 17-19. FIG. 17 is a cross-sectional view showing an electrochemical device to which a separator according to an embodiment is applied. FIG. 18 is a cross-sectional view showing a membrane-electrode assembly that may be applied to an electrochemical device. FIG. 19 is an enlarged view of a portion of the membrane-electrode assembly of FIG. 18. Hereinafter, an electrochemical device 300 is described based on a water electrolysis device including a membrane-electrode assembly 303 as an electrochemical cell, but may also be applied to other types of electrochemical devices such as fuel cells. In addition, a solid oxide cell instead of a polymer electrolyte membrane may be used. Referring to FIG. 17, the electrochemical device 300 includes a plurality of separators 301 and 302 and a membrane-electrode assembly 303 disposed therebetween. Additionally, porous current collection layers 304 and 305 may be disposed between the membrane-electrode assembly 303 and the separators 301 and 302, and it may be preferable that the porous current collection layer 304 and 305 have excellent oxidation resistance to maintain excellent electrical conductivity. When the electrochemical device 300 is used as a water electrolysis device, water is supplied as fuel, and the water may be electrolyzed to be separated into hydrogen and oxygen. To improve the function of the electrochemical device 300, a unit including the separators 301 and 302 and the membrane-electrode assembly 303 may be provided in plural and in a repeated manner to form a stack.

At least one of the plurality of separators 301 and 302 may be a separator having a flow path structure of at least one of the previously described embodiments. This embodiment illustrates an example in which this structure is applied to all of the plurality of separators 301 and 302. Alternatively, the separator of the present disclosure may be applied only to the fuel electrode-side separator 301.

The membrane-electrode assembly 303 will be described with reference to FIGS. 18 and 19. The membrane-electrode assembly 303 includes, as its main components, a first catalyst electrode 310, a polymer electrolyte membrane 320, and a second catalyst electrode 330. In this case, the polymer electrolyte membrane 320 is disposed between the first and second catalyst electrodes 310 and 330. The first catalyst electrode 310 may include a first catalyst 311 and include an aggregate of first catalyst (311) particles, as illustrated in FIG. 19. In addition to the first catalyst 311, the first catalyst electrode 310 may include an ion conductor 312, and the ion conductor 312 may function as a binder for the first catalyst 311. In addition, pores V1 may be formed within the first catalyst electrode 310 to allow smooth movement of gas, liquid, or the like. The first catalyst 311 may be active in an oxygen generation reaction and may include an Ir-based, Ru-based, or Ti-based material. The ion conductor 312 may provide a movement path for hydrogen ions or the like generated from the first catalyst electrode 310 and may include, for example, a fluorinated ionomer, a carbon-hydrogen ionomer, a mixture thereof, and the like. As a detailed example, the ion conductor 312 may include a perfluorinated sulfonic acid ionomer. In the case of a water electrolysis cell, the first catalyst electrode 310 is an anode, and water supplied thereto may be separated into oxygen (O₂), hydrogen ions (H⁺, Protons), and electrons. In this case, hydrogen ions move to the second catalyst electrode 330 through the polymer electrolyte membrane 320, and electrons may move to the second catalyst electrode 330 via an external circuit and power supply.

The polymer electrolyte membrane 320 may include an ion conductor to provide a migration path for hydrogen ions or the like. In this case, the ion conductor of the polymer electrolyte membrane 320 may include, for example, a fluorinated ionomer, a carbon-hydrogen ionomer, or a mixture thereof. As a detailed example, the ion conductor 312 may include a perfluorinated sulfonic acid ionomer. In the case of a water electrolysis cell, hydrogen ions generated at the first catalyst electrode 310 may move to the second catalyst electrode 330 through the polymer electrolyte membrane 320. As illustrated, the polymer electrolyte membrane 320 covers a side surface S1 and an upper surface S2 of the first catalyst electrode 310, thereby increasing the interface therebetween. This increased interface between the polymer electrolyte membrane 320 and the first catalyst electrode 310 promotes material exchange therebetween, thereby improving the reaction efficiency at the first and second catalyst electrodes 310 and 330.

The second catalyst electrode 330 includes a second catalyst 331 and is disposed on the polymer electrolyte membrane 320. In this case, the second catalyst 331 may be provided in a form supported on a support 333, as illustrated in FIG. 19. Additionally, the second catalyst electrode 330 may include an ion conductor 332, and the ion conductor 332 may function as a binder for the second catalyst 331 and the support 333. In addition, pores V2 may be formed within the second catalyst electrode 330 to allow smooth movement of gases, liquids, or the like. The second catalyst 331 may be active in hydrogen oxidation reaction or oxygen reduction reaction, and may include platinum (Pt), gold (Au), ruthenium (Ru), osmium (Os), palladium (Pd), and alloys thereof. The ion conductor 332 may provide a movement path for hydrogen ions, or the like, and may include, for example, a fluorinated ionomer, a carbon-hydrogen ionomer, a mixture thereof, and the like. As a detailed example, the ion conductor 332 may include a perfluorinated sulfonic acid ionomer. The support 333 may be formed as a porous body having a high surface area to support a large amount of the second catalyst 331, and for example, a carbon-based support may be used. In the case of a water electrolysis cell, the second catalyst electrode 330 is a cathode, and hydrogen ions supplied through the polymer electrolyte membrane 320 may react with electrons to produce hydrogen.

As set forth above, according to an embodiment, in the case of a separator for an electrochemical device, electrochemical reactions may be activated across the entire flow path. Furthermore, a unit flow path structure suitable for large-area expansion may be provided.

Furthermore, when the separator is applied to an electrochemical device, high performance may be obtained.

While example embodiments have been illustrated and described above, it will be apparent to those skilled in the art that modifications and variations could be made without departing from the scope of the present disclosure as defined by the appended claims.

What is claimed is:

1. A separator for an electrochemical device comprising:
a main plate; and
a flow path disposed in the main plate,
wherein the flow path includes a first flow path extending in a first direction and a second direction such that a fluid can flow from the first direction to the second direction, a second flow path extending in the first direction and the second direction such that the fluid can flow from the second direction to the first direction, and a serpentine flow path disposed between the first and second flow paths.

2. The separator of claim 1, wherein the first and second directions are perpendicular to each other.

3. The separator of claim 1, wherein the first flow path includes a fluid branching structure.

4. The separator of claim 3, wherein the first flow path includes
a plurality of first-direction flow paths extending in the first direction, and
a second-direction flow path connected to the plurality of first-direction flow paths and extending in the second direction.

5. The separator of claim 4, wherein the fluid branching structure of the first flow path is disposed in an area in which the first-direction flow paths and the second-direction flow path are connected.

6. The separator of claim 1, wherein the second flow path includes a fluid branching structure.

7. The separator of claim 6, wherein the second flow path includes
a second-direction flow path extending in the second direction, and
a plurality of first-direction flow paths connected to the second-direction flow path and extending in the first direction.

8. The separator of claim 7, wherein the fluid branching structure of the second flow path is disposed in an area in which the first-direction flow paths and the second-direction flow path are connected.

9. The separator of claim 1, wherein the serpentine flow path includes a plurality of fluid branching structures.

10. The separator of claim 9, wherein the serpentine flow path includes
a plurality of first-direction flow paths extending in the first direction, and
a second-direction flow path disposed between the plurality of first flow paths, connected to the plurality of first-direction flow paths, and extending in the second direction.

11. The separator of claim 10, wherein the serpentine flow path further includes a plurality of additional second-direction flow paths extending in the second direction and forming the plurality of fluid branching structures with the respective first-direction flow paths,
wherein the plurality of additional second-direction flow paths are disposed on opposite sides to each other based on the plurality of first-direction flow paths.

12. The separator of claim 11, wherein the fluid branching structures of the serpentine flow path are respectively disposed in the plurality of first-direction flow paths.

13. The separator of claim 1, wherein the first and second flow paths are separated from the serpentine flow path.

14. The separator of claim 1, wherein the first and second flow paths are connected to the serpentine flow path.

15. The separator of claim 1, wherein the flow path has a curved side surface.

16. A separator for an electrochemical device, comprising:
a main plate; and
a plurality of unit flow path structures disposed in the main plate,
wherein at least one unit flow path structure among the plurality of unit flow path structures includes a first flow path, a second flow path, and a serpentine flow path disposed between the first and second flow paths, each of the first, second, and serpentine flow paths including a fluid branching structure.

17. The separator of claim 16, wherein the plurality of unit flow path structures are arranged in a first direction and a second direction.

18. The separator of claim 17, wherein the at least one unit flow path structure includes a first unit flow structure and a second unit flow path structure adjacent in the first direction,
wherein the serpentine flow path of the first unit flow path structure is connected to the first flow path of the second unit flow path structure.

19. The separator of claim 18, wherein the second flow path of the first unit flow path structure is connected to the serpentine flow path and the first flow path of the second unit flow path structure.

20. The separator of claim 19, wherein the at least one unit flow path structure further includes a third unit flow path structure adjacent to the first unit flow path structure in the second direction,
and the serpentine flow path of the first unit flow path structure is connected to the second flow path of the third unit flow path structure.

21. The separator of claim 20, wherein the first flow path of the first unit flow path structure is connected to the serpentine flow path of the third unit flow path structure.

22. The separator of claim 17, wherein the first and second directions are perpendicular to each other, and
the plurality of unit flow path structures are arranged in a grid pattern.

23. The separator of claim 22, wherein a number of the plurality of unit flow path structures arranged in the first direction and a number of the plurality of unit flow path structures arranged in the second direction are the same.

24. The separator of claim 22, wherein a number of the plurality of unit flow path structures arranged in the first direction and a number of the plurality of unit flow path structures arranged in the second direction are different.

25. The separator of claim 22, wherein among the plurality of unit flow path structures, one of unit flow path structures diagonally facing each other does not include the first flow path, and the other does not include the second flow path.

26. A separator for an electrochemical device comprising:
a main plate including a first region of an outer side and a second region surrounded by the first region;
a first through-hole and a second through-hole disposed in the first region;
an internal flow path disposed in the second region;
a first fluid passage and a second fluid passage connecting the first through-hole and the internal flow path; and
a third fluid passage and a fourth fluid passage connecting the internal flow path and the second through-hole,
wherein the second region includes a first edge, a second edge, a third edge and a fourth edge, the first and third edges opposing each other in a first direction, and the second and fourth edges opposing each other in a second direction,
the first and second fluid passages are connected to the internal flow path at the first and second edges, respectively, and
the third and fourth fluid passages are connected to the internal flow path at the third and fourth edges, respectively.

27. The separator of claim 26, wherein the first fluid passage is provided as a plurality of first fluid passages, and
in the first region, a first common flow path connected to the plurality of first fluid passages and the first through-hole is disposed.

28. The separator of claim 27, wherein the second fluid passage is provided as a plurality of second fluid passages, and
in the first region, a second common flow path connected to the plurality of second fluid passages and the first through-hole is disposed.

29. The separator of claim 28, wherein the third fluid passage is provided as a plurality of third fluid passages, and
in the first region, a third common flow path connected to the plurality of third fluid passages and the second through-hole is disposed.

30. The separator of claim 29, wherein the fourth fluid passage is provided as a plurality of fourth fluid passages, and
in the first region, a fourth common flow path connected to the plurality of fourth fluid passages and the second through-hole is disposed.

31. The separator of claim 26, wherein the internal flow path includes a first connecting passage connected to the first and second fluid passages.

32. The separator of claim 31, wherein the first connecting passage includes a serpentine flow path.

33. The separator of claim 31, wherein the internal flow path further includes a second connecting passage connected to the third and fourth fluid passages.

34. The separator of claim 33, wherein the second connecting passage includes a serpentine flow path.

35. The separator of claim 33, wherein the first and second connecting passages are connected to each other within the second region.

36. The separator of claim 35, wherein the internal flow path further includes a third connecting passage connected to the second and third fluid passages.

37. The separator of claim 36, wherein the third connecting passage is separated from the first and second connecting passages.

38. The separator of claim 36, wherein the third connecting passage is connected to the first and second connecting passages within the second region.

39. The separator of claim 36, wherein the internal flow path further includes a fourth connecting passage connected to the first and fourth fluid passages.

40. The separator of claim 39, wherein the fourth connecting passage is separated from the first and second connecting passages.

41. The separator of claim 39, wherein the fourth connecting passage is connected to the first and second connecting passages within the second region.

42. The separator of claim 26, wherein each of the first and second through-holes is provided in a single instance.

43. The separator of claim 42, wherein the first and second through-holes are disposed diagonally opposite each other on the main plate.

44. The separator of claim 26, wherein each of the first and second through-holes is provided in plural.

45. An electrochemical device comprising:
a plurality of separators, each of which is the separator of claim 1; and
an electrochemical cell disposed between the plurality of separators.

46. The electrochemical device of claim 45, wherein the electrochemical cell includes a first catalyst electrode and a second catalyst electrode, and a polymer electrolyte membrane disposed between the first and second catalyst electrodes.
